(19) United States
(12) Patent Application Publication
(10) Pub. No.: US 2019/0368719 A1
(43) Pub. Date: Dec. 5, 2019

(54) LAMP DEVICE

(71) Applicant: ARC SOLID-STATE LIGHTING CORPORATION, Hsinchu City (TW)

(72) Inventor: Li-Chang YANG, Hsinchu City (TW)

(73) Assignee: ARC SOLID-STATE LIGHTING CORPORATION, Hsinchu City (TW)

(21) Appl. No.: 16/422,490

(22) Filed: May 24, 2019

(30) Foreign Application Priority Data
May 31, 2018 (TW) 107207178

(51) Int. Cl. F21V 29/71; F21V 29/503

(52) U.S. Cl. CPC F21V 29/71; F21Y 2115/10; F21V 29/503

(57) ABSTRACT

The disclosure provides a lamp device. The lamp device includes a metal cover, a heat conductive plate, a light board, and at least one first heat pipe. The heat conductive plate is disposed on the metal cover. The light board is located at a side of the heat conductive plate. One end of the at least one first heat pipe is connected to the heat conductive plate, and another end of the at least first heat pipe is connected to the light board. The light board and the heat conductive plate are spaced apart from each other by a distance.

### CROSS-REFERENCE TO RELATED APPLICATIONS

This non-provisional application claims priority under 35 U.S.C. § 119(a) on Patent Application No(s). 107207178 filed in Taiwan, R.O.C. on May 31, 2018, the entire contents of which are hereby incorporated by reference.

### TECHNICAL FIELD

The disclosure relates to a lamp device, more particularly to a lamp device having a light board suitable for various shapes of cover.

### BACKGROUND

Light-emitting diode (LED) is a semiconductor light source that has a longer lifespan, more power saving and efficient than incandescent light bulb. Besides, LEDs can be grouped up to produce higher luminance light, and its color temperature can be changed to fit the environment. Therefore, LEDS are widely used in daily life.

There are various shapes of cover for meeting the requirements of different application and aesthetic appearance of lamp. Conventionally, the light board should be specifically made in order to fit the shape of the cover and thus increasing the cost of manufacturing the lamp. Therefore, a lamp device that is suitable for different shapes of cover is desirable.

### SUMMARY OF THE INVENTION

One embodiment of the disclosure provides a lamp device. The lamp device includes a metal cover, a heat conductive plate, a light board, and at least one first heat pipe. The heat conductive plate is disposed on the metal cover. The light board is located at a side of the heat conductive plate. One end of the at least one first heat pipe is connected to the heat conductive plate, and another end of the at least first heat pipe is connected to the light board. The light board and the heat conductive plate are spaced apart from each other by a distance.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a lamp device according to a first embodiment of the disclosure;

FIG. 2 is another perspective view of the lamp device in FIG. 1; and

FIG. 3 is a perspective view of a lamp device according to a second embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

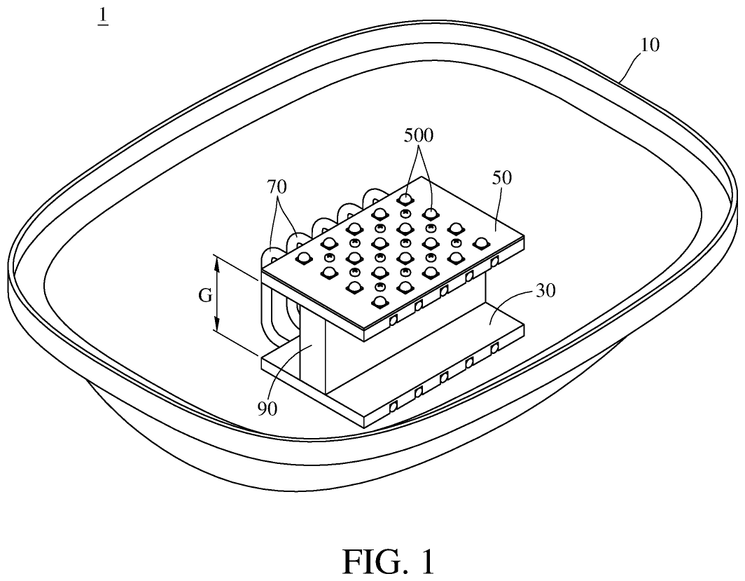

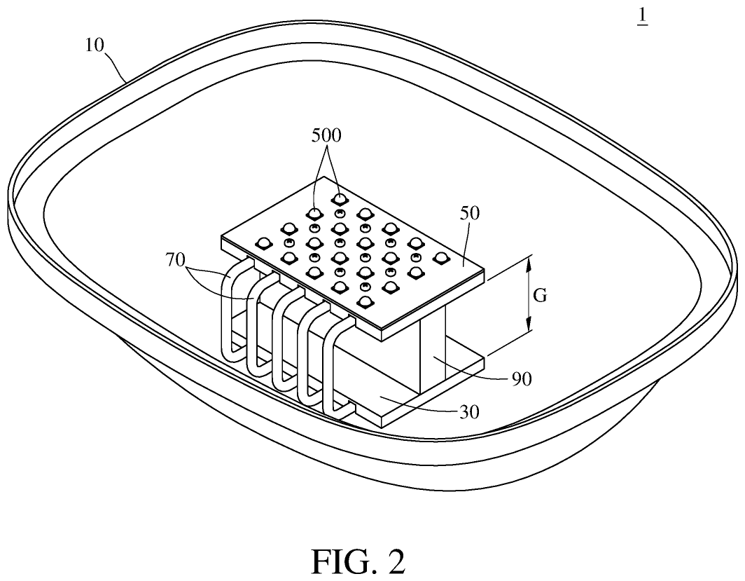

Please refer to FIGS. 1 and 2. FIG. 1 is a perspective view of a lamp device according to a first embodiment of the disclosure. FIG. 2 is another perspective view of the lamp device in FIG. 1

This embodiment provides a lamp device 1. The lamp device 1 may be incorporated into, for example, a bay lamp, a ceiling lamp, a flood lamp or other types of light emitting device. In this embodiment, the lamp device 1 includes a metal cover 10, a heat conductive plate 30, a light board 50, at least one first heat pipe 70, and a support component 90.

The heat conductive plate 30 is disposed on and in thermal contact with the metal cover 10. The light board 50 is located at a side of the heat conductive plate 30, and the light board 50 has a plurality of light-emitting units 500. Each of the light-emitting units 500 is a high power light-emitting diode (LED) configured to meet the requirement of high luminance, but the power and type of the light-emitting unit are not restricted. In some other embodiments, the light-emitting unit may be a middle or low power light-emitting unit; in another embodiment, the light-emitting unit may be an incandescent light bulb.

In this embodiment, there are more than one first heat pipes 70. One end of the first heat pipe 70 is connected to the heat conductive plate 30, and the other end of the first heat pipe 70 is connected to the light board 50. And the light board 50 is held in position by the first heat pipes 70 so that the light board 50 is spaced apart from the heat conductive plate 30 by a distance (G) approximately ranging between 1 mm and 300 mm. As such, the light board 50 is held above and not directly disposed on the metal cover 10, such that the light board 50 can be incorporated to various shapes of metal cover 10. In other words, a specific type of light board will be able to fit different designs of the metal cover 10. This helps to reduce the cost of the lamp device 1. In addition, the distance G may approximately range between 5 mm and 300 mm.

Further, the support component 90 is disposed between and connected to the heat conductive plate 30 and the light board 50 so as to secure the position of the light board 50 relative to the heat conductive plate 30.

In this embodiment, the end of the first heat pipe 70 connected to the heat conductive plate 30 is also in thermal contact with the metal cover 10. Therefore, as the first heat pipes 70 absorb heat generated by the light board 50, the heat in the first heat pipes 70 can be transmitted to the metal cover 10 through the heat conductive plate 30 and can be directly transmitted to the metal cover 10, achieving high efficiency in heat dissipation.

In this embodiment, the lamp device 1 has five first heat pipes 70, but the quantity of the first heat pipes 70 is not restricted and can be altered. For example, in some other embodiments, the lamp device may only have one or more first heat pipes 70.

In addition, the first heat pipe 70 is fixed to the heat conductive plate 30 and the light board 50 by, for example, welding process, embedding process, compressing process, or adhering process.

Furthermore, the support component 90 is optional. In some other embodiments, the lamp device may not have the support component 90; in such a case, the light board 50 is fixed in position merely by the first heat pipe 70.

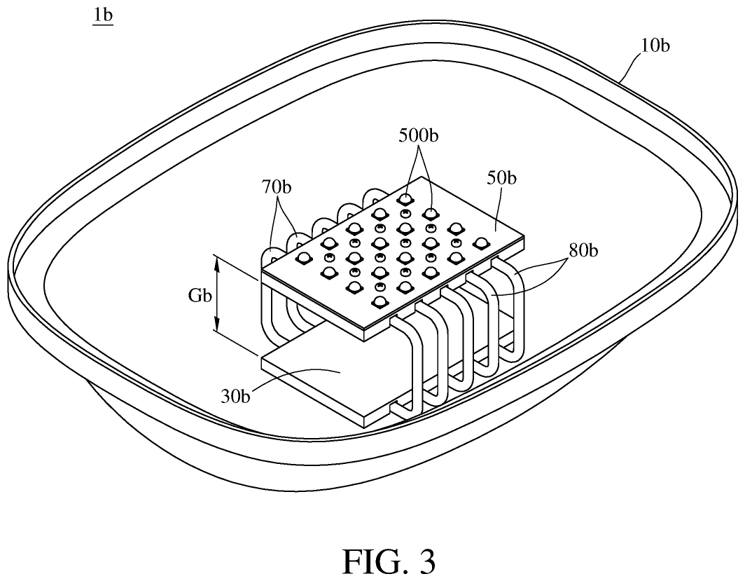

Moreover, the lamp device may have an additional set of heat pipes for supporting the light board. In detail, please refer to FIG. 3. FIG. 3 is a perspective view of a lamp device according to a second embodiment of the disclosure.

This embodiment provides a lamp device 1b. The lamp device 1b includes a metal cover 10b, a heat conductive plate 30b, a light board 50b, at least one first heat pipe 70b, and at least one second heat pipe 80b.

The heat conductive plate 30b is disposed on and in thermal contact with the metal cover 10b. The light board 50b is located at a sides of the heat conductive plate 30b, and the light board 50b has a plurality of light-emitting units 500b.

In this embodiment, there are more than one first heat pipes 70b and second heat pipes 80b. One end of the first heat pipe 70b and one end of the second heat pipe 80b are respectively connected to two opposite sides of the heat conductive plate 30b, and the other end of the first heat pipe 70b and the other end of the second heat pipe 80b are respectively connected to two opposite sides of the light board 50b. And the light board 50b is held in position by the first heat pipes 70b and the second heat pipes 80b, such that the light board 50b is spaced apart from the heat conductive plate 30b by a distance (Gb).

Since the light board 50b is held by the first heat pipes 70b and the second heat pipes 80b, the position of the light board 50b relative to the heat conductive plate 30b can be secured.

In this embodiment, the lamp device 1b has five first heat pipes 70b, but the quantity of the first heat pipes 70b is not restricted and can be altered. For example, in some other embodiments, the lamp device may only have one or more first heat pipes. Similarly, in another embodiment, the lamp device may only have one or more second heat pipes.

According to the lamp devices as discussed above, the light board is held above and spaced apart from the heat conductive plate by a specific distance by the first heat pipe, such that the light board is spaced apart from the metal cover. Therefore, the light board can be incorporated to various shapes of metal cover. In other words, due to the first heat pipe, a specific type of light board will be able to fit different designs of the metal cover. This helps to reduce the cost of the lamp device.

In addition, the support component is disposed between and connected to the heat conductive plate and the light board so as to secure the position of the light board relative to the heat conductive plate.

Moreover, the light board is held by the first heat pipes and the second heat pipes 80b, thus the position of the light board relative to the heat conductive plate can be secured.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A lamp device, comprising:
a metal cover;
a heat conductive plate disposed on the metal cover;
a light board located at a side of the heat conductive plate; and
at least one first heat pipe, wherein one end of the at least one first heat pipe is connected to the heat conductive plate, another end of the at least first heat pipe is connected to the light board, and the light board and the heat conductive plate are spaced apart from each other by a distance.

2. The lamp device according to claim 1, further comprising a support component, wherein the support component is disposed between and connected to the heat conductive plate and the light board.

3. The lamp device according to claim 1, wherein the distance approximately ranges between 1 millimeter and 300 millimeters.

4. The lamp device according to claim 3, wherein the distance approximately ranges between 5 millimeters and 300 millimeters.

5. The lamp device according to claim 1, wherein the end of the at least one first heat pipe which is connect to the heat conductive plate is in thermal contact with the metal cover.

6. The lamp device according to claim 1, wherein the quantity of the at least one first heat pipe is plural.

7. The lamp device according to claim 1, further comprising at least one second heat pipe, wherein the one end of the at least one first heat pipe and one end of the at least one second heat pipe are respectively connected to two opposite sides of the heat conductive plate, and the another end of the at least one first heat pipe and another end of the at least one second heat pipe are respectively connected to two opposite sides of the light board.

8. The lamp device according to claim 7, wherein the quantities of the at least one first heat pipe and the at least one second heat pipe are plural.

9. The lamp device according to claim 1, wherein the light board has at least one light-emitting unit.

10. The lamp device according to claim 9, wherein the at least one light-emitting unit is a high power light-emitting diode.
